(19) United States
(12) Patent Application Publication
(10) Pub. No.: US 2026/0004269 A1
(43) Pub. Date: Jan. 1, 2026

(54) SYSTEMS AND METHODS FOR ENHANCED TWO-FACTOR AUTHENTICATION USING PROXIMITY

(71) Applicant: T-Mobile Innovations LLC, Overland Park, KS (US)

(72) Inventors: Ahmad AL ACCAD, Renton, WA (US); Zoltan HOMORODI, North Bend, WA (US)

(21) Appl. No.: 18/756,813

(22) Filed: Jun. 27, 2024

(51) Int. Cl. G06Q 20/20; G06Q 20/40; H04L 9/32

(52) U.S. Cl. CPC G06Q 20/206; G06Q 20/4015; H04L 9/3228

(57) ABSTRACT

Systems and methods are provided for enhance Two-Factor Authentication using proximity. This may include receiving a request to perform an account transaction with an account of a wireless device requiring a One-Time Password (OTP) from a requesting device. The distance between the requesting device and the wireless device may be calculated. If the distance is at or below a first distance threshold, the OTP may be transmitted to the wireless device. If the distance is above the first threshold, secondary authorization may be required before transmitting the OTP to the wireless device. If the distance is above a second distance threshold, higher than the first distance threshold, the account transaction may be denied.

### TECHNICAL BACKGROUND

Wireless subscriber accounts are increasingly becoming sought after targets of cyber-criminals. The accounts can be bought and sold, used to make large fraudulent purchases, used as vectors to target other user accounts, and even used in other criminal activities. There are many ways in which an account may be taken over, including so-called SIM swap schemes. Reducing the instances of fraudulent use of customer accounts leads to better customer experience and saves time and money for the wireless providers and their customers.

### OVERVIEW

Examples described herein include systems and methods for enhanced two-factor authentication using proximity. An exemplary method includes receiving a request to perform an account transaction with an account of a wireless device requiring a One-Time Password (OTP) from a requesting device. The method further includes calculating a distance between the requesting device and the wireless device. The method further includes in response to the distance being at or below a first distance threshold, transmitting the OTP to the wireless device. The method further includes in response to the distance being above the first distance threshold, requiring secondary authorization before transmitting the OTP to the wireless device.

Another exemplary embodiment includes a system with an identity provider, including at least one electronic processor configured for executing instructions to perform operations. The operations include receiving a request to perform an account transaction with an account of a wireless device requiring a One-Time Password (OTP) from a requesting device. The operations further include calculating a distance between the requesting device and the wireless device. The operations further include in response to the distance being at or below a first distance threshold, transmitting the OTP to the wireless device. The operations further include in response to the distance being above the first distance threshold, requiring secondary authorization before transmitting the OTP to the wireless device

Another exemplary method includes receiving a request to perform an account transaction requiring a One-Time Password (OTP) at an identity provider from a requesting device. The method further includes determining a location of the requesting device using a location provider. The method further includes determining a location of a wireless device designated as a Two-Factor Authentication (2FA) receiver of an account for the account transaction. The method further includes calculating a distance between the requesting device and the wireless device. The method further includes in response to the distance being at or below a first distance threshold, transmitting the OTP to the wireless device. The method further includes in response to the distance being above the first distance threshold, requiring secondary authorization before sending the OTP to the wireless device.

### BRIEF DESCRIPTION OF DRAWINGS

These and other more detailed and specific features of various embodiments are more fully disclosed in the following description, reference being had to the accompanying drawings, in which:

FIG. 1 illustrates an example system for wireless communication in accordance with various aspects of the present disclosure;

FIG. 2 illustrates an example system for enhanced two-factor authentication using proximity in accordance with various aspects of the present disclosure;

FIG. 3 illustrates an example processing node in accordance with various aspects of the present disclosure;

FIG. 4 illustrates an example process flow for enhanced two-factor authentication using proximity; and

FIG. 5 illustrates an example process flow for enhanced two-factor authentication using proximity.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

Access to a wireless account may be made available to the account holder via the wireless provider’s website, customer service portal, mobile application (app), in the wireless provider’s store locations or via a phone call to the wireless provider’s customer care number. In a store, the person requesting access to the account is expected to have the wireless device in question, unless it is lost, and to answer security questions, such as the last four digits of the account holder’s social security number, for example. Similarly, customer care representatives will ask security questions before permitting access to the wireless account.

For website and app access, the account holder is required to login to their account to gain access to their account details, usually by way of a username and password. Once authenticated, the account holder can perform many different functions such as changing information of the account, adding or removing devices or lines, ordering or activating new equipment, changing a SIM card for a device, or changing service levels, for example. There are also many functions that are common to other types of online accounts as well, such as changing the account’s password or the account holder’s contact information including mailing address or email address.

Short Messaging Service (SMS) One-Time Passwords (OTPs) are a common method of Two Factor Authentication (2FA) for online accounts. OTPs are often a short set of numbers or letters and numbers. Wireless providers often send an OTP to the registered mobile phone number when a user of their website or app tries to login. That mobile phone number is designated as the receiver of OTPs. The user is then required to enter the OTP into the website or app to complete the authentication process.

Online accounts, whether for wireless subscribers or otherwise, also have mechanisms for when an account holder forgets their username or password. Often this is presented at the login page as a link for resetting a forgotten username or password. Activating the forgotten password option will present the user with options to verify the person requesting the password reset. For example, if the account profile includes security questions and answers, then that will be one of the possible ways to verify the user. Other ways of verifying the user include sending an OTP to the account holder’s email address or sending an OTP via SMS to the account holder’s phone number. The user may select the SMS OTP option which will start the process for sending the OTP.

One increasingly common attack on wireless accounts and users is a SIM swap attack. This type of attack occurs when a bad actor impersonates a victim to the victim’s wireless provider in order to hijack the mobile phone number of the user. For example, the bad actor could trigger the reset password mechanism and select the SMS OTP option for further authorization. If the bad actor can gain access to the OTP, they can gain control of the account and replace the victim’s wireless device with the bad actor’s phone in the account. The bad actor’s phone now has the mobile phone number of the victim. The bad actor can now reset the password for the victim’s online banking account and receive the OTP on the replacement phone, thus gaining access to the victim’s bank account. Often, once the bad actor has access to the phone number, they can gain access to the victim’s email giving them access to a second 2FA vector as OTPs may be sent via email as well as SMS. This can often give the bad actor access to many accounts of the victim. Banking access can be used to steal money. Access to email, photos or messaging apps can be used for identity theft or to extort victims threatening the release of private information.

Separately and in conjunction with SIM swap attacks, OTPs sent via SMS have increasingly been coming under attack by bad actors using phishing methods on unsuspecting victims. Phishing is a social engineering attack where the victim is convinced to divulge confidential information under false pretenses. A common scheme is to send an SMS message to the victim claiming they have won something, such as money and stating that all they need to do is confirm the OTP that they will send. The bad actor then triggers the reset password mechanism or 2FA enabled account login process causing the cellular provider to send an OTP to the account holder’s phone. If the account holder falls for the scheme, they then send the OTP to the bad actor by replying to the phishing SMS message with the OTP. The bad actor then uses the OTP to reset the password or login to the account holder’s account and now has full access to the account. Even though there is always a warning accompanying the OTP stating never to share the OTP with anyone, it is often ignored by those falling for phishing schemes such as these. These types of phishing attacks may be thwarted by adding an extra confirmation step. One example extra step includes checking the proximity of the device requesting the account transaction that triggers the OTP and the wireless device that will actually receive the OTP before continuing the process of accessing the account. If a legitimate user is accessing the provider’s website or app and requires an OTP be sent to their wireless device, the wireless device should be in the same location as the device used to access the website or app. Often this will be the same device.

Wireless devices report their location to their wireless providers regularly and necessarily for the provision of the wireless services. For example, when a wireless device requests to place a call, it will create a request and send it to the wireless provider. Included in the call request is a report of the wireless device’s current location. This location data is used at the Gateway Mobile Location Center (GMLC) to help determine the correct routing of the call request to reach the destination of the call. This location data is also stored in a database with much more information from and about all wireless devices connecting to the wireless provider’s network. The stored information includes information on which access nodes a wireless device connects to and when, wireless device usage statistics, and much more. This historical information is maintained for troubleshooting, billing and other uses. The location of a wireless device may be determined by having the identity provider query a service delivery gateway which works with the GMLC to access the database and return the location to the identity provider. The location may be an estimated latitude and longitude of the device, for example.

The device from which a person requests a transaction would need to have its location determined. One method of determining the location of a device is by using the IP address of the device. The IP address may be captured when it is determined that the requested account transaction is one that requires further authorization by way of an OTP. The IP address may be transmitted to a location provider which looks up the IP address in a database and provides a location in response. The location may be a zip code, city or town or it may be an estimated latitude and longitude of the device, for example.

The wireless device designated as the 2FA receiver of an account may be determined by querying a database containing account information. The distance between the designated wireless device and the device from which the requested transaction is initiated may be calculated. That distance may be compared to a first distance threshold. As previously mentioned, those devices should be in close proximity to each other and are often the same device. Location determination is not perfectly accurate, so the first distance threshold would account for that. The first distance threshold may be determined by the wireless provider depending on their risk tolerance. For example, the first distance threshold may be set to 10 miles, 50 miles, or 100 miles. The distance may then be compared to a second distance threshold higher than the first. The second distance threshold may be 200 miles or higher, for example. Any useful values may be used for each threshold provided the second distance threshold is higher than the first distance threshold.

If the distance is at or below the first distance threshold, the risk may be considered low, and the OTP may be transmitted to the designated wireless device normally. If the distance is higher than the first distance threshold and at or below the second distance threshold, secondary authorization may be required to proceed with the transaction. Once the secondary authorization has been completed successfully, the OTP may be transmitted to the wireless device and the process continues as normal. If the distance is above the second distance threshold, the transaction may be denied, and a message may be sent to the account holder describing the requested transaction and the reason it was denied, including a warning that someone may have been attempting to fraudulently access the account holder’s account. Alternatively, the second distance threshold may be omitted meaning all transactions with a distance above the first distance threshold would require secondary authorization.

Secondary authorization may include receiving a positive response to a confirmation text message. For example, once it is determined that secondary authorization is required, an SMS message may be sent to the wireless device stating that a risky transaction has been detected and require that the user reply with a positive confirmation that it is them requesting the transaction. Other examples of secondary authorization may require the user to authenticate using biometric authentication on the wireless device, an authenticator app, or pass key authentication.

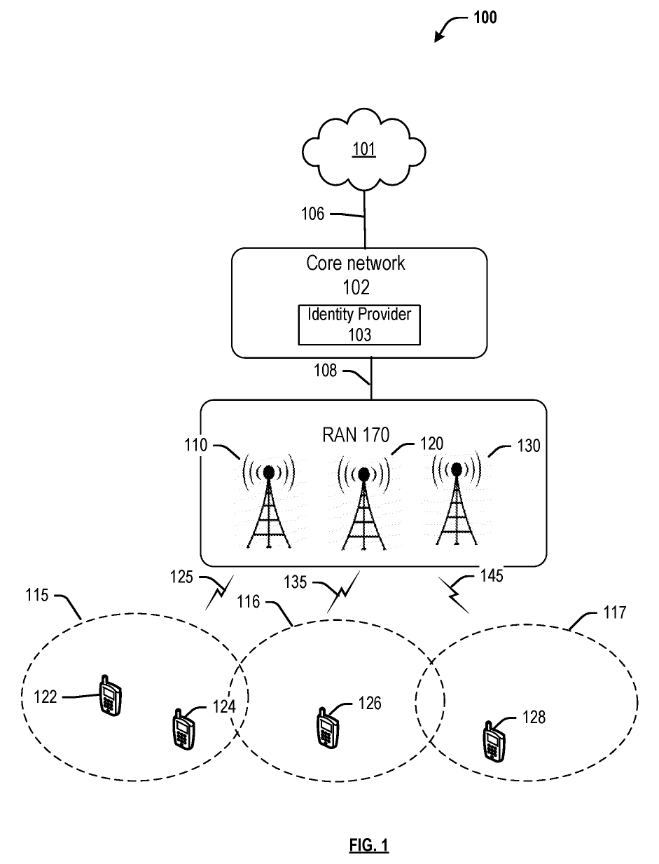

FIG. 1 depicts an exemplary system 100 for wireless communication, in accordance with the disclosed embodiments. System 100 may include a communication network 101, core network 102, and a radio access network (RAN) 170 including access nodes 110, 120, and 130. The RAN 170 may include other devices and additional access nodes. Although three access nodes are shown, any number of access nodes may be included.

System 100 also includes multiple wireless devices 122, 124, 126, and 128, which may be end-user wireless devices and may operate within one or more coverage areas 115, 116, and 117. The wireless devices 122, 124, 126, 128 communicate with access nodes 110, 120, and/or 130 within the RAN 170 over communication links 125, 135, and 145, which may for example be 4G or 5G communication links.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise Fourth Generation mobile networks or wireless systems (4G or 4G LTE) or Fifth Generation mobile networks or wireless systems (5G). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

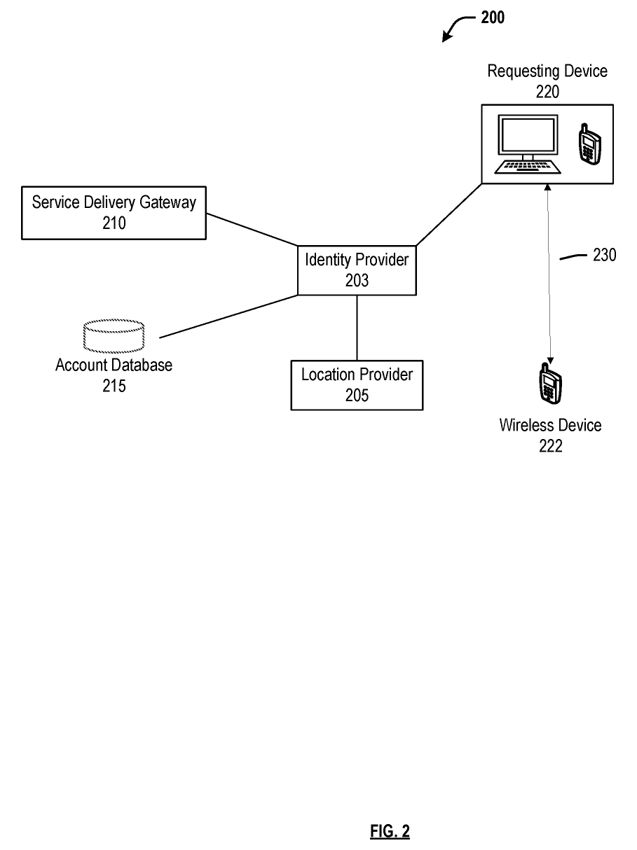

Identity Provider 103 may be located at any point within the wireless provider’s network, including within core network 102 as shown in FIG. 1. It will be explained further in relation to FIG. 2. Core network 102 includes a number of server functions necessary for the operation of a wireless network which are omitted in FIG. 1 for clarity. Core network 102 may be separated into user plane functions and control plane functions. The user plane accesses a data network, such as network 101, and performs operations such as packet routing and forwarding, packet inspection, policy enforcement for the user plane, quality of service (QoS) handling, etc. The control plane handles radio-specific functionality that depends on the idle or connected states of the wireless devices 122, 124, 126, and 128.

Communication links 106 and 108 can use various communication media, such as air, space, metal, optical fiber, or some other signal propagation path - including combinations thereof. Communication links 106 and 108 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 5G, 6G, NTN, or combinations thereof.

Communication links 106 and 108 can be direct links or might include various equipment, intermediate components, systems, and networks, such as a cell site router, etc. Communication links 106 and 108 may comprise many different signals sharing the same link.

The RAN 170 may include various access network systems and devices such as access nodes 110, 120, 130. The RAN 170 is disposed between the core network 102 and the end-user wireless devices 122, 124, 126, 128. Components of the RAN 170 may communicate directly with the core network 102 and others may communicate directly with the end user wireless devices 122, 124, 126, 128. The RAN 170 may provide services from the core network 102 to the end-user wireless devices 122, 124, 126, and 128.

The RAN 170 includes multiple access nodes (or base stations) 110, 120, 130, which may include one or more access nodes communicating with the plurality of end-user wireless devices 122, 124, 126, 128. It should be understood that the disclosed technology may also be applied to communication between an end-user wireless device and other network resources, such as relay nodes, controller nodes, antennas, etc. The RAN 170 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access nodes 110, 120, 130 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes 110, 120, 130 may comprise a short range, low power, small-cell access node such as a microcell access node, a picocell access node, a femtocell access node. Access nodes 110, 120, 130 can be configured to deploy one or more different carriers, utilizing one or more RATs. Any other combination of access nodes and carriers deployed therefrom may be evident to those having ordinary skill in the art in light of this disclosure.

The access nodes 110, 120, 130, and identity provider 103 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless devices 122, 124, 126, and 128 may be any device, system, combination of devices, or other such communication platform capable of communicating wirelessly with access node 110, 120, and 130 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless devices 122, 124, 126, 128 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless devices 122, 124, 126, and 128.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the radio access network 170 and the core network 102.

FIG. 2 illustrates an example system 200 for enhanced two-factor authentication using proximity. System 200 includes an identity provider 203, such as identity provider 103 identified in FIG. 1. Requesting device 220 may be any device with access to the provider’s website or app. For example, requesting device 220 may be a computer system or a mobile device as illustrated in FIG. 2.

Identity provider 203 receives a request from requesting device 220 to perform an account operation, such as login to the provider’s website or app, or to reset the password for the account, for example. The account transaction is one that requires a One-Time Password (OTP) for authentication before allowing the account transaction. The IP address of requesting device 220 may be captured at the time that the request is made. The IP address may then be forwarded by identity provider 203 to location provider 205, which returns the location of requesting device 220. Identity provider 203 determines that wireless device 222 is designated to receive OTPs for the account by querying account database 215. Wireless device 222 may be one of the wireless devices 122, 124, 126, or 128 from FIG. 1, for example. The location of wireless device 222 may be determined by querying service delivery gateway 210 which has access to a database containing location information for wireless device connected to the wireless provider’s network directly or in combination with a GMLC. Other ways to determine a location for wireless device 222 may utilize GPS, antenna patterns, location based services (LBS), such a triangulation, communication patterns, Bluetooth, Wifi and combinations thereof to determine the location of wireless device 222. Multiple towers are used to track the phone’s location by measuring the time delay that a signal takes to return back to the towers from the phone.

GPS utilizes satellite location and triangulation to determine the coordinates of wireless device 222. Location of wireless device 222 may also be determined based on wi-fi location, measuring power levels and antenna patterns of wireless device 222 communicating wirelessly with one or more access nodes.

A distance 230 between requesting device 220 and wireless device 222 is calculated. The distance 230 may be calculated based on a difference between the location of the requesting device 220 and the location of the wireless device 222. If the distance is at or below a first distance threshold, the process may be allowed to proceed normally, and the OTP will be transmitted to wireless device 222. However, if the distance is above the first distance threshold, secondary authorization may be required before the process is allowed to continue. Secondary authorization may include receiving a positive response to a confirmation text message, biometric authentication, email OTP confirmation, authentication via authenticator app, and pass key authentication. For example, once it is determined that secondary authorization is required, an SMS message may be sent to wireless device 222 stating that a risky transaction has been detected and require that the user reply with a positive confirmation that it is them requesting the transaction. Once the secondary authorization has been completed successfully, the OTP may be transmitted to wireless device 222 and the process continues as normal. If the secondary authorization is not completed successfully within a predetermined period of time, the account transaction may be denied, and a message may be sent to the account holder describing the requested transaction and the reason it was denied, including a warning that someone may have been attempting to fraudulently access the account holder’s account.

Optionally, the distance 230 may be compared with a second distance threshold, higher than the first distance threshold. If the distance 230 is above the second distance threshold, the account transaction may be denied and a notification to wireless device 222 may be sent indicating a possibly fraudulent attempt to access the account.

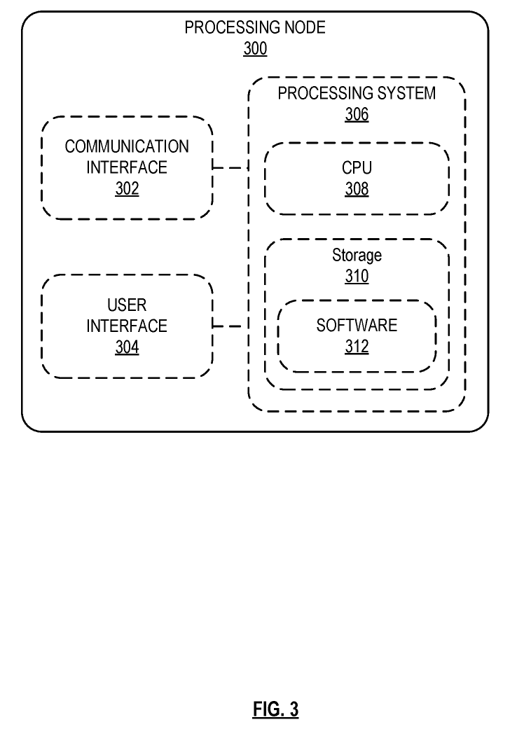

FIG. 3 depicts an example processing node 300, which may be configured to perform the methods and operations disclosed herein for enhanced two-factor authentication using proximity. The processing node 300 includes a communication interface 302, user interface 304, and processing system 306 in communication with communication interface 302 and user interface 304. Communication interface 302 may include hardware components, such as network communication ports, devices, routers, wires, antenna, transceivers, etc. User interface 304 may include hardware components, such as touch screens, buttons, displays, speakers, etc.

Processing system 306 includes a processor 308, storage 310, which can comprise a disk drive, flash drive, memory circuitry, or other memory device including, for example, a buffer. Storage 310 can store software 312 which is used in the operation of the processing node 300. Software 312 may include computer programs, firmware, or some other form of machine-readable instructions, including an operating system, utilities, drivers, network interfaces, applications, or some other type of software. Processing system 306 may include a processor 308 and other circuitry to retrieve and execute software 312 from storage 310, which may be internal or external to the processing system 306. Processing node 300 may further include other components such as a power management unit, a control interface unit, etc., which are omitted for clarity. Communication interface 302 permits processing node 300 to communicate with other network elements. User interface 304 permits the configuration and control of the operation of processing node 300. Processing node 300 may be included in various elements of the wireless network including an identity provider such as identity provider 103 in FIG. 1 or identity provider 203 in FIG. 2, for example.

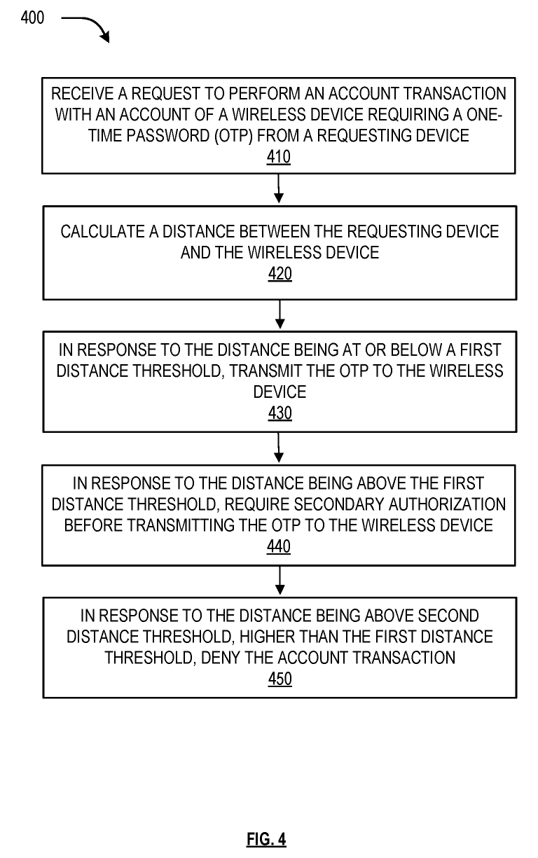

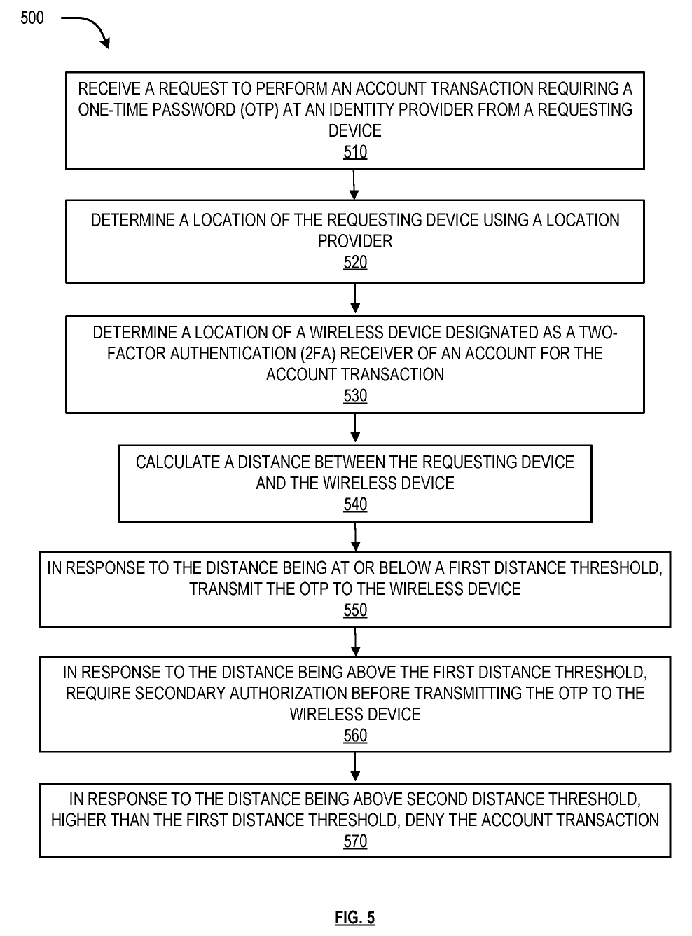

In exemplary embodiments, software 212 may include instructions for the operations disclosed above with respect to FIG. 2 or the methods disclosed below with respect to FIGS. 4 and 5.

FIG. 4 illustrates an exemplary method 400 of enhanced two-factor authentication using proximity. Method 400 may be performed by any suitable combination of processors discussed herein, for example a processor contained in an identity provider.

Method 400 begins in step 410 where a request to perform an account transaction with an account of a wireless device requiring a One-Time Password (OTP) is received from a requesting device. An account transaction may include requesting a password reset through a forgotten password mechanism, or attempting to login to the account, for example. Method 400 continues in step 420 where a distance between the requesting device and the wireless device is calculated.

The IP address of the requesting device may be captured at the time that the request is made. The IP address may then be forwarded by the identity provider to a location provider, which returns the location of the requesting device. The identity provider determines that the wireless device is designated to receive OTPs for the account by querying an account database. The location of the wireless device may be determined by querying a service delivery gateway which has access to a database containing location information for wireless devices connected to the wireless provider’s network either directly or through a GMLC. Other ways to determine location for the wireless device may utilize GPS, antenna patterns, location-based services (LBS), such a triangulation, communication patterns, Bluetooth, Wi-Fi and combinations thereof to determine the location of the wireless device. Multiple towers are used to track the phone’s location by measuring the time delay that a signal takes to return back to the towers from the phone. GPS utilizes satellite location and triangulation to determine the coordinates of the wireless device. Location of the wireless device may also be determined based on wi-fi location, measuring power levels and antenna patterns of the wireless device communicating wirelessly with one or more access nodes. The distance between the requesting device and the wireless device may be calculated based on a difference between the locations of the requesting device and the wireless device.

Method 400 continues in step 430 where the OTP is transmitted to the wireless device in response to the distance being at or below a first distance threshold. Method 400 continues in step 440 where secondary authorization is required before transmitting the OTP to the wireless device in response to the distance being above the first distance threshold. Method 400 may continue with optional step 450 where the account transaction is denied in response to the distance being above a second distance threshold, higher than the first distance threshold. If the account transaction is denied, a notification may be sent to the wireless device indicating the nature of the account transaction and the reason for the denial as well as a warning that the account transaction request may have been fraudulent.

FIG. 5 illustrates an exemplary method 500 of enhanced two-factor authentication using proximity. Method 500 may be performed by any suitable combination of processors discussed herein, for example a processor contained in an identity provider.

Method 500 begins in step 510 where a request to perform an account transaction requiring a One-Time Password (OTP) is received from a requesting device. An account transaction may include requesting a password reset through a forgotten password mechanism, or attempting to login to the account, for example.

Method 500 continues in step 520 where a location of the requesting device is determined using a location provider. The IP address of the requesting device may be captured as part of the requested account transaction. The IP address may then be forwarded to the location provider which may look up the IP address in a database and provide a location in response. The location returned may be a zip code, city or town or it may be an estimated latitude and longitude of the device.

Method 500 continues in step 530 where a location of a wireless device designated as a Two-Factor Authentication (2FA) receiver of an account for the account transaction is determined. The location of the wireless device may be determined by querying a service delivery gateway which has access to a database containing location information for wireless devices connected to the wireless provider’s network either directly or in conjunction with a GMLC. Other ways to determine location for the wireless device may utilize GPS, antenna patterns, location-based services (LBS), such a triangulation, communication patterns, Bluetooth, Wi-Fi and combinations thereof to determine the location of the wireless device. Multiple towers are used to track the phone’s location by measuring the time delay that a signal takes to return back to the towers from the phone. GPS utilizes satellite location and triangulation to determine the coordinates of the wireless device. Location of the wireless device may also be determined based on wi-fi location, measuring power levels and antenna patterns of the wireless device communicating wirelessly with one or more access nodes.

Method 500 continues in step 540 where a distance between the requesting device and the wireless device is calculated. The distance between the requesting device and the wireless device may be calculated based on a difference between the locations of the requesting device and the wireless device.

Method 500 continues in step 550 where the OTP is transmitted to the wireless device in response to the distance being at or below a first distance threshold. Method 500 continues in step 560 where secondary authorization is required before transmitting the OTP to the wireless device in response to the distance being above the first threshold. Method 500 may continue with optional step 570 where the account transaction is denied in response to the distance being above a second threshold, higher than the first threshold. If the account transaction is denied, a notification may be sent to the wireless device indicating the nature of the account transaction and the reason for the denial as well as a warning that the account transaction request may have been fraudulent.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving a request to perform an account transaction with an account of a wireless device requiring a One-Time Password (OTP) from a requesting device;
calculating a distance between the requesting device and the wireless device;
in response to the distance being at or below a first distance threshold, transmitting the OTP to the wireless device; and
in response to the distance being above the first distance threshold, requiring secondary authorization before transmitting the OTP to the wireless device.

2. The method of claim 1, wherein the secondary authorization comprises at least one of: receiving a positive response to a confirmation text message, biometric authentication, email OTP confirmation, authentication via authenticator app, and pass key authentication; and wherein the method further comprises:
in response to successful secondary authorization, transmitting the OTP to the wireless device.

3. The method of claim 1, wherein the account transaction is one of resetting an account password, and logging into the account.

4. The method of claim 1, the method further comprising:
in response to detecting the account transaction requires the OTP, capturing an IP address of the requesting device.

5. The method of claim 4, the method further comprising:
determining a location of the requesting device by sending an IP address of the requesting device to a location provider and receiving the location of the requesting device from the location provider.

6. The method of claim 1, the method further comprising:
determining the wireless device where the OTP will be transmitted by querying an account database for a phone number associated with the account.

7. The method of claim 1, the method further comprising:
determining a location of the wireless device by transmitting a request for the location of the wireless device to a service delivery gateway.

8. The method of claim 1, wherein the method further comprises:
in response to the distance being above a second distance threshold higher than the first distance threshold, transmitting a notification of the request to perform the account transaction to the wireless device without transmitting the OTP.

9. A system, the system comprising:
an identity provider, including at least one electronic processor configured for executing instructions to perform operations including:
receiving a request to perform an account transaction with an account of a wireless device requiring a One-Time Password (OTP) from a requesting device;
calculating a distance between the requesting device and the wireless device;
in response to the distance being at or below a first distance threshold, transmitting the OTP to the wireless device; and
in response to the distance being above the first distance threshold, requiring secondary authorization before transmitting the OTP to the wireless device.

10. The system of claim 9, wherein the secondary authorization comprises at least one of: receiving a positive response to a confirmation text message, biometric authentication, email OTP confirmation, authentication via authenticator app, and pass key authentication; and wherein the operations further comprise:
in response to successful secondary authorization, transmitting the OTP to the wireless device.

11. The system of claim 9, wherein the account transaction is one of resetting an account password, and logging into the account.

12. The system of claim 9, the operations further comprising:
in response to detecting the account transaction requires the OTP, capturing an IP address of the requesting device.

13. The system of claim 9, the operations further comprising:
determining a location of the requesting device by sending an IP address of the requesting device to a location provider and receiving the location of the requesting device from the location provider.

14. The system of claim 9, the operations further comprising:
determining the wireless device where the OTP will be transmitted by querying an account database for a phone number associated with the account.

15. The system of claim 9, the operations further comprising:
determining a location of the wireless device by transmitting a request for the location of the wireless device to a service delivery gateway.

16. The system of claim 9, the operations further comprises:
in response to the distance being above a second distance threshold higher than the first distance threshold, transmitting a notification of the request to perform the account transaction to the wireless device without transmitting the OTP.

17. A method, the method comprising:
receiving a request to perform an account transaction requiring a One-Time Password (OTP) at an identity provider from a requesting device;
determining a location of the requesting device using a location provider;
determining a location of a wireless device designated as a Two-Factor Authentication (2FA) receiver of an account for the account transaction;
calculating a distance between the requesting device and the wireless device;
in response to the distance being at or below a first distance threshold, transmitting the OTP to the wireless device; and
in response to the distance being above the first distance threshold, requiring secondary authorization before sending the OTP to the wireless device.

18. The method of claim 17, wherein the secondary authorization comprises at least one of: receiving a positive response to a confirmation text message, biometric authentication, email OTP confirmation, authentication via authenticator app, and pass key authentication; and wherein the method further comprises:
in response to successful secondary authorization, transmitting the OTP to the wireless device.

19. The method of claim 17, wherein the account transaction is one of resetting an account password, and logging into the account.

20. The method of claim 17, wherein the method further comprises:
in response to the distance being above a second distance threshold higher than the first distance threshold, transmitting a notification of the request to perform the account transaction to the wireless device without transmitting the OTP.
